(19) United States
(12) Patent Application Publication
(10) Pub. No.: US 2016/0162917 A1
(43) Pub. Date: Jun. 9, 2016

(54) SYSTEM AND METHOD FOR EVALUATING AND INCREASING CUSTOMER ENGAGEMENT

(71) Applicant: Zafin Labs Technologies Ltd., Dubai (AE)

(72) Inventors: Suman Kumar Singh, Bangalore (IN); Aditya Khandekar, Bangalore (IN); Dinesh Krishnan, Ottawa (CA); Sagnik Chakravarty, Kolkata (IN)

(21) Appl. No.: 14/959,191

(22) Filed: Dec. 4, 2015

Related U.S. Application Data
(60) Provisional application No. 62/088,134, filed on Dec. 5, 2014.

(51) Int. Cl. G06Q 30/02

(52) U.S. Cl. CPC G06Q 30/0204

(57) ABSTRACT

A method and system for determining and improving the engagement between a customer and a company offering products and/or services is disclosed. As part of the process, a customer engagement score (“CES”) is calculated. The CES is a composite number that is used to measure how engaged and loyal a company's customers are. Each customer has their unique CES based on activity, relationship, usage of company product and services, rewards and their emotional and rational engagement with the company. Based on the CES, at least one recommended action to improve customer engagement is provided.

### CLAIM OF PRIORITY AND CROSS-REFERENCE TO RELATED APPLICATION

This application claims the benefit of and priority to U.S. Provisional Patent Application No. 62/088,134, which was filed on Dec. 5, 2014, and is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The present invention relates to customer centricity and customer engagement, and, more particularly, to a system and method for evaluating and improving customer engagement.

### BACKGROUND

There are many ways that customers can acquire products or services in the current marketplace, such as via internet transactions, at a traditional store, at a point-of-sale machine, by catalog, and other methods. Additionally, a customer may use several products or services from the same company, especially when that company has numerous offerings. Furthermore, a larger company may have numerous separate divisions for particular offerings.

As a result, a customer may have numerous interactions with the same company. However, due to different sales channels, different offerings, and different divisions with the same company, as well as other factors, these interactions can be very different from transaction to transaction. Thus, the customer can be left feeling like the “little guy” because it does not appear the company is even aware that the customer is an existing customer in another area. Even though a customer may be a high volume and/or high value customer for a particular offering, that customer may be treated the same as a non-customer in regards to a different offering, alternative sales channel, or when doing business with another segment of the same company.

Additionally, among a group of customers, one customer may have a significantly different level of engagement with a company than another customer. For example, one customer may only conduct a couple of transactions per year with the company, whereas another customer is performing many transactions on a regular basis, such as within the same week. Furthermore, one customer may rely on the company for a number of goods or services, whereas another customer may only transact with the company for a single offering or a single class of goods or services. Thus, it is desirable to distinguish between different types of customers, and identify specific actions to address disengaged customers and reward highly engaged customers.

For many reasons, it is highly desirable to develop a method for evaluating a customer's engagement with a particular company, and take specific actions according to that analysis. Such a capability will allow a company to recognize a valuable customer even when the company's interaction with that customer spans, for example, multiple sales channels, offerings, and company divisions. Such a capability can also identify specific actions to improve engagement with customers that only have limited transactions with the company. This can directly lead to increased customer loyalty, increased sales, and greater customer retention. Aspects of the present disclosure fulfill these and other desires.

### SUMMARY

According to aspects of the present invention, a method for evaluating and improving customer engagement is presented. According to some embodiments, a method comprises receiving transaction information for a plurality of customers, identifying a segment applicable to at least one customer based on the transaction information, selecting a list of preferred variables for determining a customer engagement score, determining the best value for each of the preferred variables, calculating a customer engagement score for at least one customer, and determining at least one recommendation to improve engagement for that customers, the recommendation based at least in part on the analysis of the customer engagement score and the identified segment for that customer.

According to further aspects of the present invention, a method comprises receiving transaction information for a plurality of customers, identifying a segment applicable to a customer based on the transaction information, calculating a weighted index from a set of selected variables based on the transaction information, determining a customer engagement score for at least one customer from the weighted index, displaying a summary analysis for the identified segment including the customer engagement score for at least one customer, evaluating the sensitivity of the customer engagement score in view of changes to the selected variables to identify highly sensitive variables, and recommending a strategy to improve that customer's engagement score by impacting the value of a highly sensitive variable.

Additional aspects of the invention will be apparent to those of ordinary skill in the art in view of the following figures, detailed description, and claims.

### BRIEF DESCRIPTION OF THE DRAWINGS

Exemplary embodiments are illustrated in referenced figures. It is intended that the embodiments and figures disclosed herein are to be considered illustrative rather than restrictive.

FIG. 1 is a flow chart detailing the overall process for determining a customer engagement score and determining a recommended action based on that score, according to an embodiment of the present disclosure.

FIG. 2 is a diagram of a Common Data Model (CDM), according to an embodiment of the present disclosure.

FIG. 3 is a diagram of an attribute table comprising the Analytics Data Mart, according to an embodiment of the present disclosure.

FIG. 4 is a variable description, according to an embodiment of the present disclosure.

FIG. 5 is a diagram showing the Emotional, Rational, Relationship, Reward and Active (ERRRA) components of a customer engagement score, according to an embodiment of the present invention.

FIG. 6 is a flowchart of a method for determining a customer engagement score, according to an embodiment of the present disclosure.

FIG. 7 is a diagram showing potential benefits of the application of a customer engagement score, according to an embodiment of the present disclosure.

FIGS. 8-12 show screen captures from the application of the customer engagement scoring process, according to embodiments of the present disclosure.

FIG. 13 is a flowchart of an engagement optimization process, according to an embodiment of the present disclosure.

FIG. 14-16 show example uses cases demonstrating how the customer engagement process can identify insights into customer behavior and determine actions to improve engagement, according to embodiments of the present disclosure.

FIG. 17 is a diagram showing segmentation of customers based on their transaction history, according to an embodiment of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.” Additionally, the singular terms “a,” “an,” and “the” include plural referents unless context clearly indicates otherwise.

The embodiments disclosed herein provide a method and system for determining and improving the engagement between a customer and a company offering products and/or services. Important to this process is the determination of a customer engagement score (CES). The CES is a composite number that may be used to measure how engaged and loyal a company's customers are. Each customer relationship may be analyzed by the CES process based on activity, relationship, usage of company product and services, rewards and their emotional & rational engagement with the company.

The higher the score, the higher the engagement quality and greater the opportunity to drive profitability for that particular customer. Additionally, a high CES suggests opportunities to further expand the relationship with that customer, potentially in place of a competitor's products and services.

The CES is instructive in identifying gaps between customer behavior and customer engagement. Additionally, the CES can be used to sharpen the acquisition and retention strategy for targeted customers, including strategic adjustment of reward programs or other loyalty programs.

The CES is, among other things, a predictor of a customer's intrinsic loyalty value. The CES provides a quantifiable metric that can easily be evaluated and acted upon by a company.

A roadmap is provided for evaluating and improving engagement for a card system, such as a credit card with reward redemption points. First, statistical segments for customers can be developed based on card spending and usage patterns, redemption behaviors for card rewards, merchant categories shopped, and other factors. Next, the CES is determined based on the customer's ERRRA (as discussed below). Then, the customer footprint, segment, and CES should be evaluated, using a 360 degree view of customer centricity. At this point, the card reward effectiveness should be quantified by portfolio, segment, merchant, and/or product level, and combined with a snapshot of the current reward liabilities (outstanding points balances) and expiration, to provide a baseline for future comparison. Predictive modeling is applied to measure the drivers of redemption and predict redemption behavior. Based on the CES, specific recommendations and/or next best actions are determined for improving engagement. This may include mechanism(s) to reduce reward liabilities, for example, by providing incentives for a customer to use existing rewards in a limited time period. A detailed explanation of the determination and application of the CES is provided below.

Applying the process for improving customer engagement will drive customers to stay longer with a particular company, do more business with the company, and/or better fulfill their consumption needs. The process for improving customer engagement will also improve the overall customer experience. For example, by using multiple services from the same company, a customer may receive additional benefits such as preferred pricing, saving of time, reduction in number of required transactions, and other benefits. Thus, improving customer engagement increases customer benefits as well as operational efficiency for a company doing business with that customer.

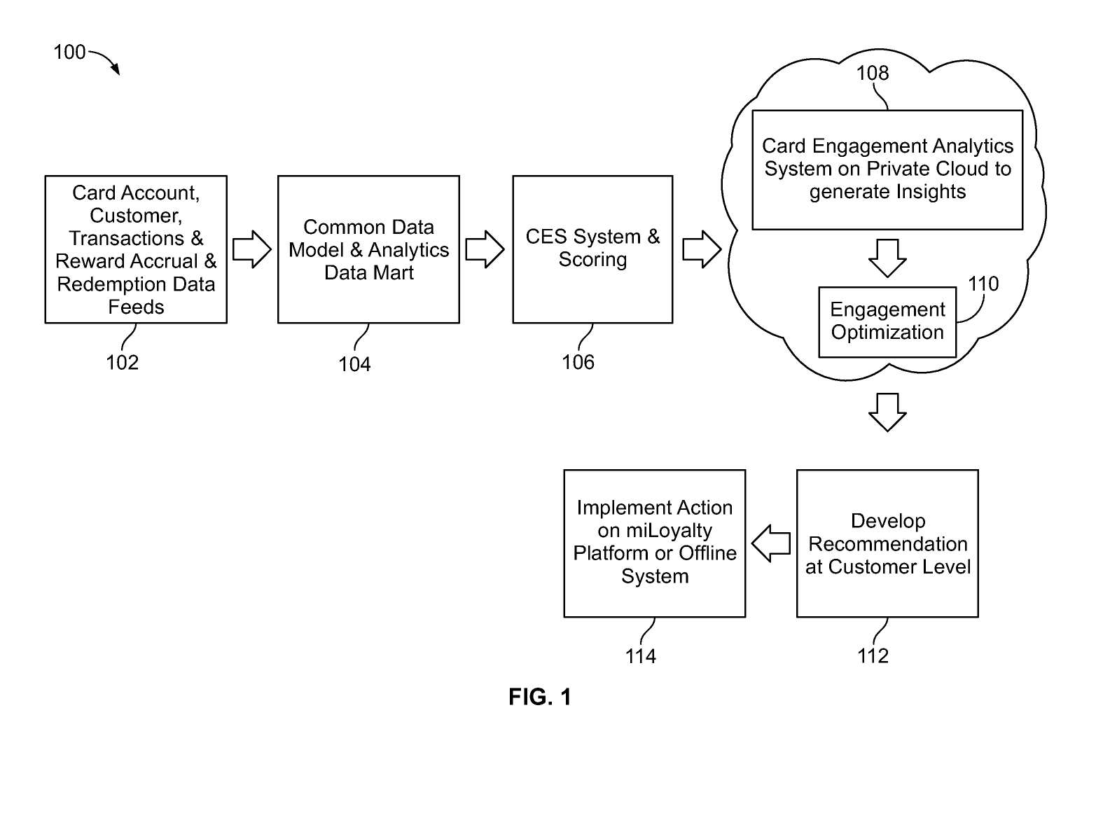

Referring now to FIG. 1, the overall process flow 100 for a customer engagement score (CES) process is shown. In this example and the following detailed discussion below of preferred embodiments, the engagement process is applied to transaction data for customer relationships across a banking portfolio, for example by evaluating liability and credit transactional data for consumer credit and/or debit cards. However, it should be understood that the engagement process can be used to analyze and generate recommended actions for other types of customer relationships using other types of transactional data. For example, the process disclosed herein can be used with transactional data relating to smart card based payment systems, mobile payment applications, phone-based payment systems, and/or other types of network-based payment systems.

At 102, a variety of information is collected by the process relating to a customer's transactional information for a card account. In some embodiments, some of this information is collected from the miLoyalty system, which provides a platform to enable loyalty, reward, and benefit programs, or a similar loyalty management platform. Such transaction-related information may include card transaction data, reward accrual data, reward maintenance and redemption data, card account and customer data, merchant tagging data, reference tables, and other transactional data. The data includes granular details for each transaction, such as time, date, amount, location, and other information.

Card transaction data includes, for example, debit transactions, credit adjustments, fees, payment data, and other related information. Reward accrual data includes, for example, reward points accrued for the account and related transactions, accrual data for banking and/or partner reward programs, adjustments to reward balances, and related information. Reward redemption data includes, for example, reward redemptions for the account, redemption options chosen, adjustments to redemptions, and related data. Card account and customer data includes, for example, snapshot data for each card account, snapshot data for each card customer, and related data. Merchant tagging data includes, for example, the detailed merchant name, numerical merchant category code (MCC) tag, and related data. Reference tables include, for example, definition tables for product, branch, transaction code, redemption option, points to currency conversion, channel, accrual related change codes, currency codes, coalition codes, and/or other definition tables.

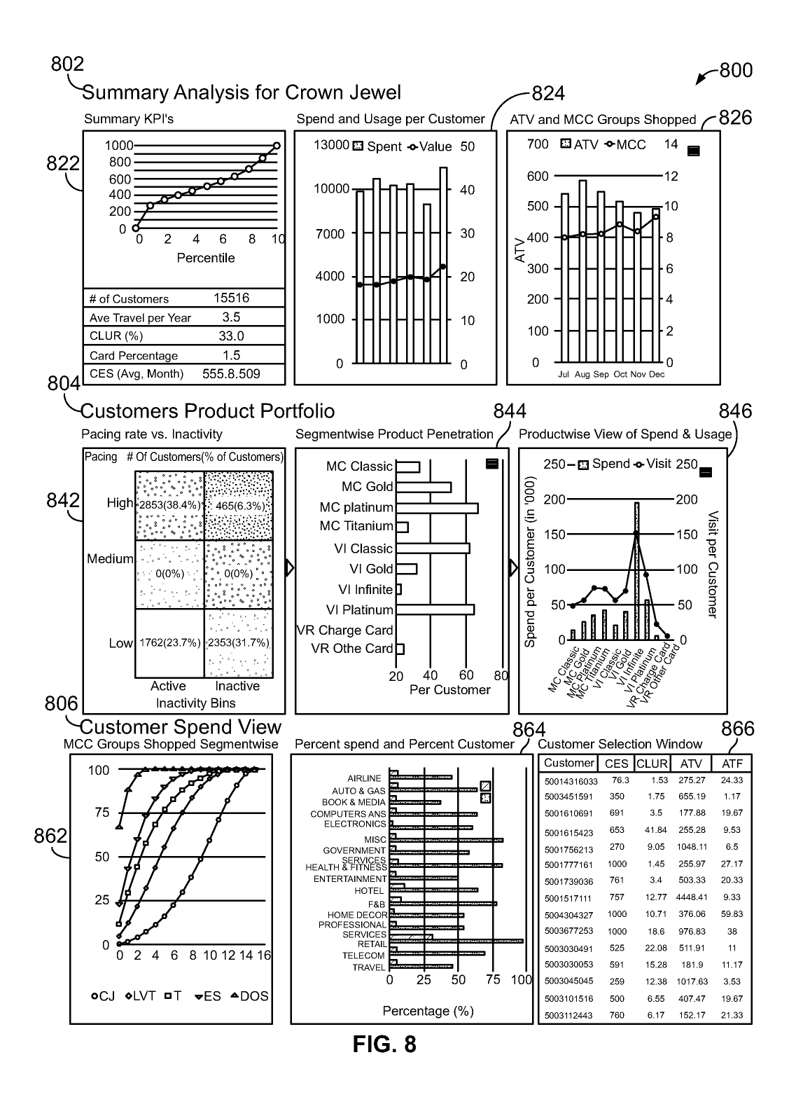

At 104, a CDM is used to store transaction-related information and identify the relationship(s) between data elements. The CDM allows for control tables and attributes tables. Control tables hold the settings to be used in the analysis, such as window dates, customers, accounts, merchants, and other parameters. Attributes tables hold the metrics and key performance indicators (KPI) to be used in the Insight Visualization Application (IVA) display. Exemplary IVA displays are shown in FIGS. 8-12 and discussed further below.

At 106, the appropriate variables are selected and the CES scoring is performed, based on the customer ERRRA (Emotional, Rational, Relationship, Reward, and Active) behavior as discussed in further detail below.

At 108, the analytics system provides detailed results of the CES process. In a preferred embodiment, these results are initially provided via a series of customizable IVA displays via a private network. As detailed further below, the results may be used to generate insights into the behavior of customers and drivers for product usage, reward redemption, new account creation, and other factors.

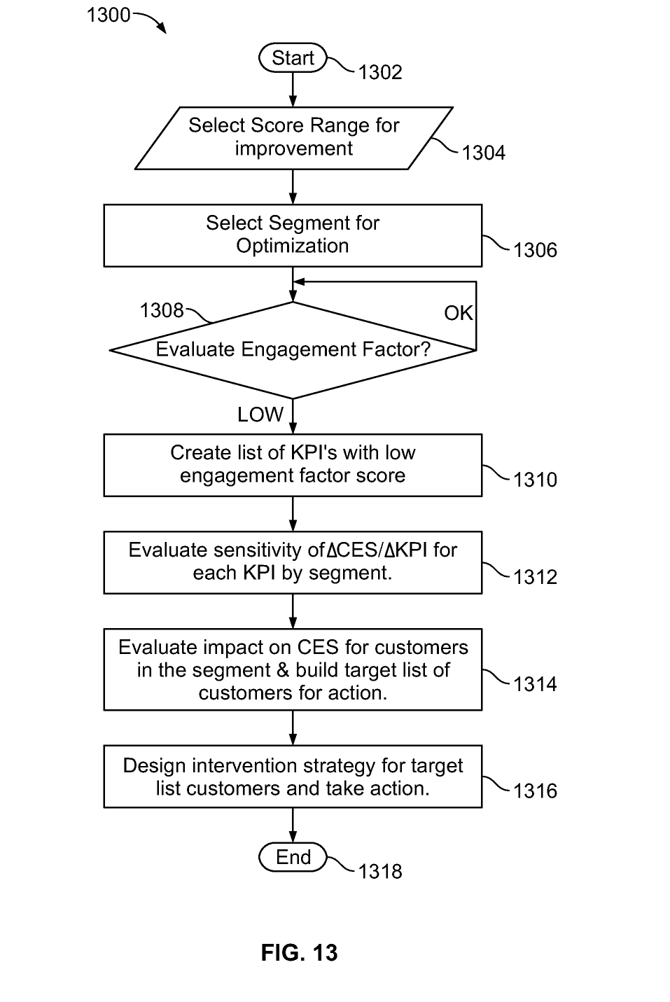

At 110, at least one strategy to optimize engagement is identified, by evaluating an area of desired improvement with respect to a specific customer segment or particular customer for optimization. This process is further detailed below and in FIG. 13.

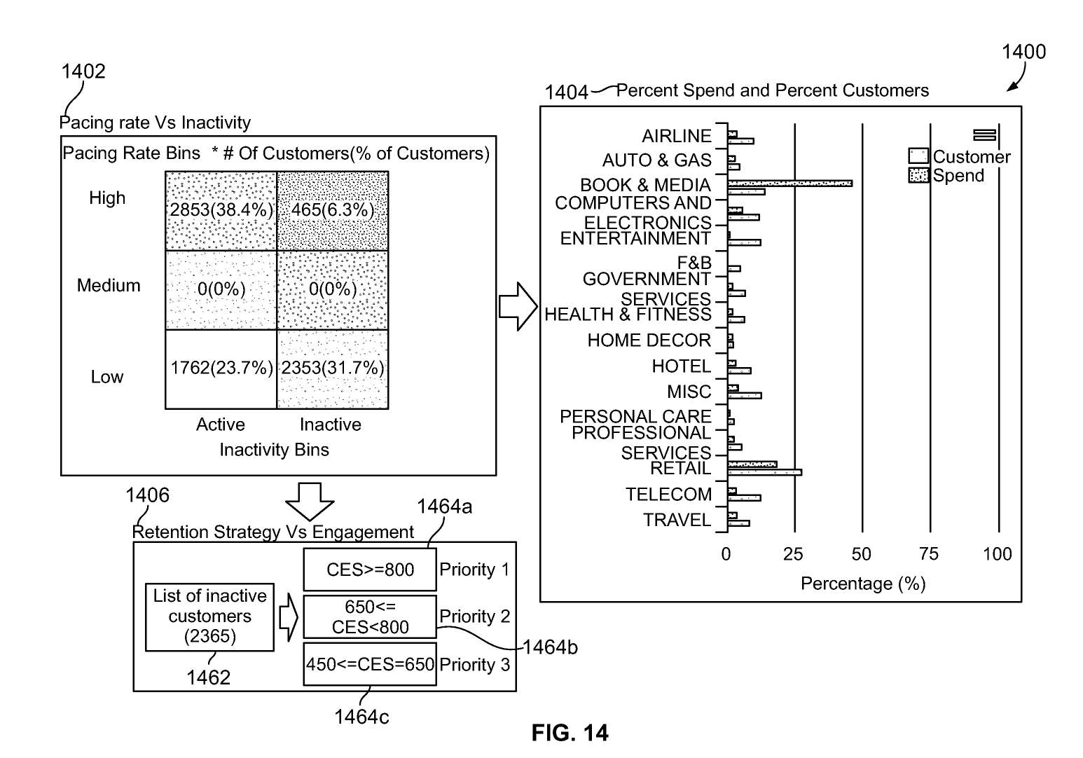

At 112, at least one recommendation is provided to implement a recommended action to improve customer engagement. Exemplary recommendations based on the CES process are detailed below in relation to FIGS. 14-16.

At 114, at least one recommended action from 112 is implemented to improve customer engagement. In some embodiments, the action is implemented using the miLoyalty platform. In other embodiments, the action may be implemented using a separate, offline process.

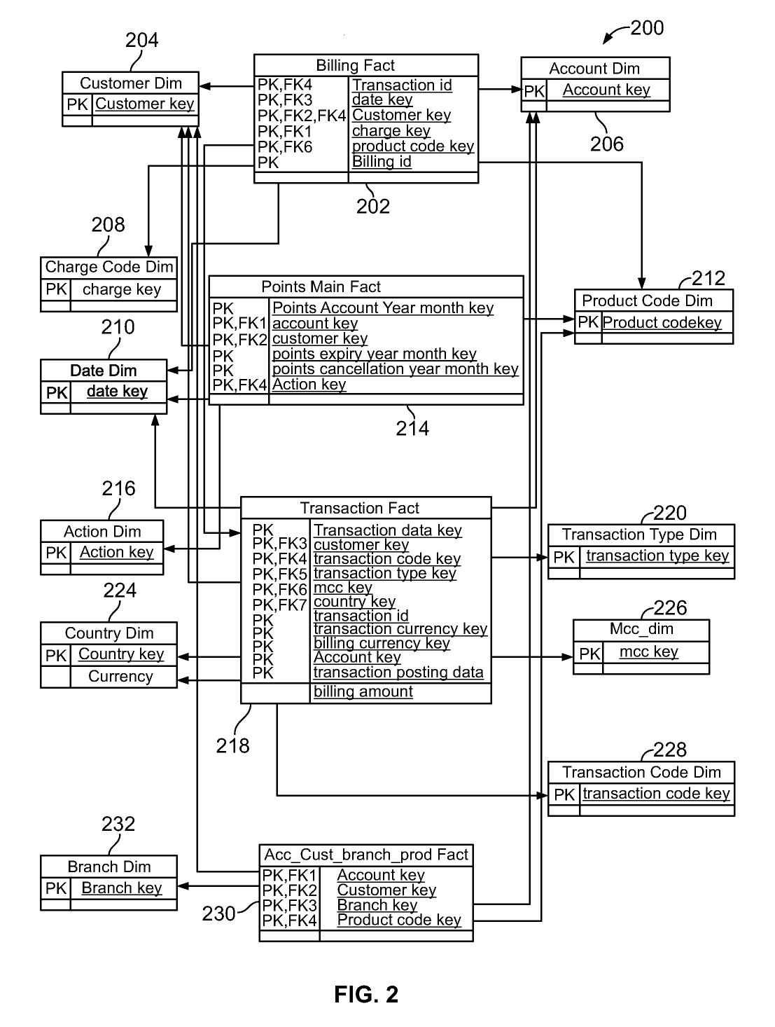

Turning to FIG. 2, an entity relationship diagram 200 is shown. The diagram 200 provides a Common Data Model (CDM) that may be used to store data related to the CES process. The model organizes data by type and shows relationships between data elements. For example, the customer key is part of the customer dimension object 204, and the customer key relates to the billing fact object 202, transaction fact object 218, points maintenance fact object 214, and acc_cust_branch_prod fact object 230. The customer key can be used as a primary key to look up data in related objects. As another example, the charge key of the charge code dimension object 208 is related to the billing fact object 202. Numerous other objects and relationships are apparent from the diagram 200 and need not be detailed further here.

The CDM provides a mechanism to store data relevant to the CES process and systematically lookup that data when needed. The diagram 200 is exemplary, and additional objects may be added or removed from the model as needed.

In addition to the CDM, an Analytics Data Mart is provided to manage control tables and attribute tables. The Analytics Data Mart sits on top of the CDM. Control tables hold settings to be used in the analysis, such as, according to some embodiments, the following tables:

The window control table includes the observation window start date, observation window end date, performance window start data, performance window end date, and last load date. The customer control table includes a list of customers selected using a specific customer selection or exclusion criteria. The account control table includes a list of accounts for the selected customers. The merchant control table includes a list of distinct merchants within the performance window. The MCC control table includes a list of distinct MCC's within the performance window. Control tables may be modified, added or removed from this exemplary list according to some embodiments of the present disclosure.

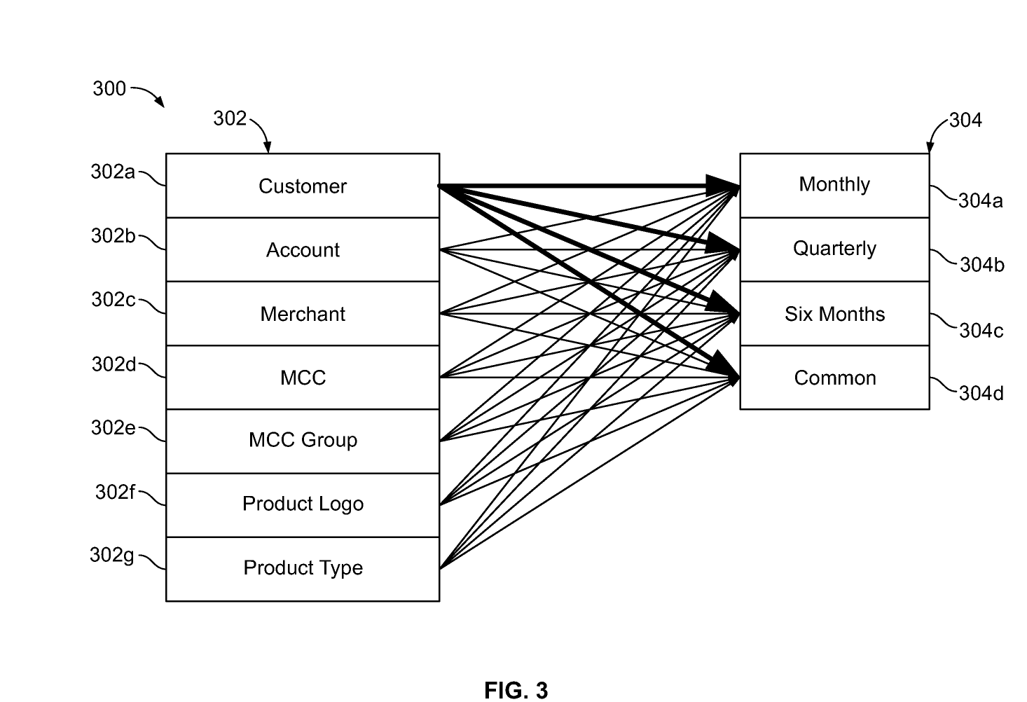

Attribute tables hold metrics and/or key performance indicators (KPI's) for use in presenting IVA reports based on the CES process. An exemplary attribute table 300 is shown in FIG. 3. The parameters 302 identify specific parameters 302a-302g which may be evaluated using the CES process, and the parameters 304 provide a time period 304a-304d for reporting on those parameters. Common 304d applies to attributes that do not fall under a specific time frame. Parameters 302 and 304 have a many-to-many relationship such that multiple parameters can be examined over multiple time periods. In some embodiments, additional parameters for reporting can be added to the attribute tables, and/or the tables may have additional reporting dimensions.

Referring back to FIG. 1, at 106, the Customer Engagement Score (CES) is determined based on the customer's Emotional, Rational, Relationship, Reward and Active (ERRRA) behavior. In order to determine a CES that best reflects the ERRRA parameters, it is important to analyze and select the proper input parameters to the process. Thus, the CES can be tailored to reflect the ERRRA related attributes. Once determined, the CES can then be used to predict and classify the engagement or intrinsic loyalty behavior of a customer and measure the drivers for purchases, reward redemption, and other transactions.

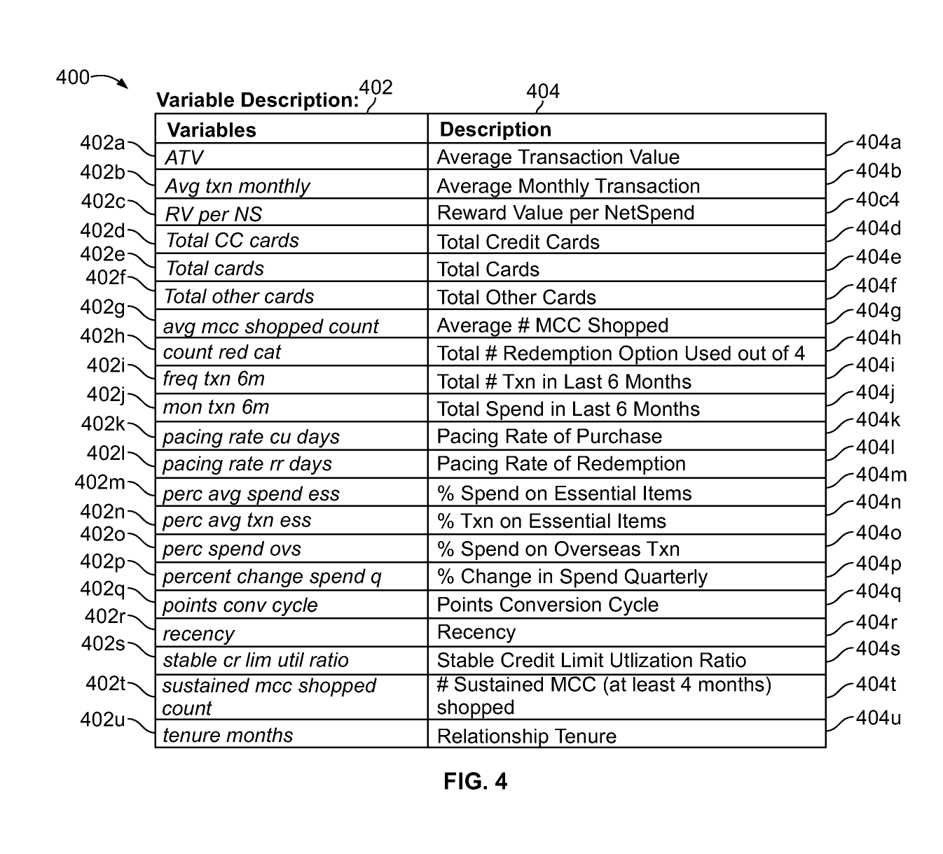

A variety of transaction-related information is collected by the system at 102. However, not all available information is appropriate for determining a particular CES. Instead, it is important to select the proper inputs to impact the ERRRA factors. For example, in a preferred embodiment, the variables described in FIG. 4 were considered as potential inputs to the system. In FIG. 4, the table 400 provides the names of variables 402a-402u and their corresponding descriptions 404a-404u. However, a preferred embodiment only uses a subset of the variables shown in FIG. 4 in the determination of the CES. In order to determine the appropriate variables to use to provide maximum impact to the ERRRA factors, an actual data set was prepared and subjected to statistical analysis to determine the most desirable inputs.

Data from various sources have been merged at account level then aggregated at customer level. The single Analytics Data Mart would be leveraged to entire customers' activities.

Using the prepared data, variance significance tests, data sufficiency tests, and normality tests can be applied to determine the preferred variables for determining CES. One such process to determine the proper variables to use as inputs to the scoring process is as follows.

First, outlier treatment using boxplot and univariate analysis is applied to each column of the data matrix. A boxplot is charted for each variable to assist in identifying outlier data. In addition, the percentile distribution for each variable is considered with respect to the tails of the chart (for example, the first and last 10 percentile points). In this example, the variables were capped as follows: the uppermost 2% values were capped with the 98^{th} percentile value, and the lowermost 2% values were capped with the 2^{nd} percentile value.

Additionally, normality tests are applied to identify non-normal variables. Also, certain variables showing high pairwise correlation (for example, r>0.60) are eliminated.

According to a preferred embodiment, the results of the above tests on the potential variables showed that the following list of variables is best suited for determining CES based on the ERRRA factors for the selected data set. Those variables are described here.

### Preferred Variables for Determination of CES

Pacing Rate. Pacing rate is defined as the average shopping interval for customers. This is calculated by taking ratio of duration between first and last transaction and number of transactions done by the customer in the period of last 6 months.

Below is the mathematical formulation of the Pacing Rate at customer level.

TABLE 1

| Outputs | Formula/Concept |
|---|---|
| First txn date(f): | min(txn_date) per customer_id |
| Last txn date(l): | max(txn_date) per customer_id |
| Txn interval in days: | (l − f) per customer_id |
| Txn count in 6 months(n): | Count of unique transaction ids |
| | per customer_id |

*(Txn = Transaction)

$$Pacing Rate of Card Usage \text{:} \frac{l - f}{n - 1} in days , \\ at a customer level \qquad ( Equation 1 )$$

Reward Redemption Interval. Reward redemption interval is defined as average number of days between two subsequent redemptions done by the redeemer customer (customer, who has redeemed at least once in last 6 months, called redeemer) over a period of 3 years.

Three years of data is used here since reward points validity in this case is 36 months from the date of accrual. Points redeemed via all types of redemption options (for example, Miles, Product, Star Card, Star Travel) are considered as a single bucket for the calculation of this metric. Below is the mathematical formulation of Reward Redemption Interval at customer level.

TABLE 2

| Outputs | Formula/Concept |
|---|---|
| First redemption date(f): | min(posting_date) per customer_id |
| Last redemption date(l): | max(posting_date) per_customer_id |
| Redemption interval in days: | (l − f) per customer_id |
| Redemption count in 3 years(n): | count of unique posting_date |
| | per customer_id |

$$Pacing Rate of Reward Redemption \text{:} \frac{l - f}{n - 1} in \\ days , at customer level \qquad ( Equation 2 )$$

Product Penetration. Product Penetration is defined as the number of products owned by the customer. Types of products are credit card, debit card, and primary DDA (Demand Deposit Account).

All types of products are counted directly from the accounts data and rolled up to customer level to calculate this metric.

TABLE 3

| Outputs | Formula/Concept |
|---|---|
| # primary DDA | Count of account_numbers where |
| product(a): | product_code belongs to DDA & |
| | “primary_shadow_account_flag == 1” |
| | per customer_id |
| # primary credit | Count of account_numbers where |
| cards(p): | product_code belongs to CC & |
| | “primary_shadow_account_flag == 1” |
| | per customer_id |
| # secondary credit | Count of account_numbers where |
| cards(s): | product_code belongs to CC & |
| | “primary_shadow_account_flag == 0” |
| | per customer_id |
| # primary debit | Count of account_numbers where |
| cards(d): | product_code belongs to DC & |
| | “primary_shadow_account_flag == 1” |
| | per customer_id |
| # total cards(t): | (a + p + s + d) per customer_id |
| # total credit | (p + s) per customer_id |
| cards(t_cc): | |
| # total other | (t − t_cc) per customer_id |
| cards(t_oth): | |

Relationship Tenure. Relationship tenure for a customer is defined as the duration between first card delivery date across portfolio and current date. In case of multiple cards, the delivery date of the first active card has been used in the calculation.

Formula to calculate this metric is the difference between first card delivery date and current date.

TABLE 4

| Outputs | Formula/Concept |
|---|---|
| First card delivery date(fc): | min(card_delivery_date) per customer_id |
| Tenure in days: (td) | (31^{st} Dec., 2013) − fc |
| Tenure in years: (ty) | td/365 |

Points Conversion Cycle (PCC). Point Conversion Cycle is defined as the weighted average life of reward points at customer level from the time of accrual to the redemption. Points redeemed via all types of redemption options (Miles, Product, Star Card, Star Travel) are considered as a single bucket for the calculation of this metric.

TABLE 5

| Outputs | Formula/Concept |
|---|---|
| Duration in month from point | (posting_date − year_month) |
| accrual to redemption (mr): | in months |
| Total points redeemed by a | sum(points) per customer |
| customer at relation to date: (tpr) | |
| Fraction of points redeemed by | (points/tpr) |
| a customer at relation to date: | |
| (fpr) | |

Mathematical derivation to calculate PCC is sum of the product of reward points' fraction and its tenure divided by total number of reward points redeemed by the customer.

Points Conversion cycle: Σ(f pr*mr)in months, at a customer level (Equation 3)

Diversified Merchant Shopped. Diversified merchant shopped is defined as the average count of Merchant Category Code (MCC) shopped by the customer over last 6 months. This metric is calculated in two dimensions: the first is count at monthly level in last 6 months, and the second is average count in last 6 months.

Unique 4 digit MCCs from the 6 months transaction data is counted at monthly and 6 month level for this metric.

TABLE 6

| Outputs | Formula/Concept |
|---|---|
| Average # of Merchants | count of unique MCC shopped |
| shopped per customer monthly | in a single month |
| Average # of Merchants | count of unique MCC shopped/6 |
| shopped per customer over 6 | |
| months | |

Recency, Frequency & Monetary. Recency, Frequency, and Monetary (RFM) is defined to understand the current transaction behavior in last 6 months.
Recency is calculated as duration between last transaction date and current date for the customer.
Frequency is calculated as total number of transactions done by the customer in last 6 months.
Monetary is calculated as total spend done by the customer in last 6 months.

Using last 6 months of transaction data, RFM is calculated as depicted in below table.

TABLE 7

| Outputs | Formula/Concept |
|---|---|
| Last txn date(l): | max(txn_date) per customer_id |
| Recency in days(rd): | (31^{st} Dec., 2013) − l |
| Recency in months(rm): | rd/30 |
| Frequency(f): | count of unique transaction ids per |
| | customer_id over last 6 months. Average |
| | transaction frequency (ATF) monthly = f/6 |
| Monetary(mt): | sum(billing_amount) per customer_id |
| | over last 6 months. Average transaction |
| | value (ATV) = mt/f has been used for |
| | analysis |

Spend Utilization on Credit Limit. Spend Utilization on Credit Limit provides a quantitative measure of how well the customer is utilizing available credit limits across cards owned by the customer.

Mathematical derivation of Spend Utilization on Credit Limit is the ratio of average monthly spends at customer level and sum of credit limits attached to all accounts for that customer.

TABLE 8

| Outputs | Formula/Concept |
|---|---|
| Total spend at Customer | sum(billing_amount) at customer |
| level(tsc): | level over last 6 months |
| Credit limit at customer | Sum of unique(credit_limit) at |
| level(clc): | account level for the customer |
| Avg monthly spend at customer | (tsc/6) |
| level (amsc): | |
| Spend Utilization on Credit | amsc/clc |
| Limit (sucl): | |

$$Spend Utilization on Credit Limit \text{:} \frac{( \sum tsc ) / 6}{\sum clc} , at \\ a customer level \qquad ( Equation 4 )$$

Overseas and Domestic Spend. Overseas and Domestic Spend provides a view of how customers are using their credit cards while traveling outside of the country. Mathematical derivation for this metric is total spends overseas or domestic divided by the total spend at customer level in last 6 months.

TABLE 9

| Outputs | Formula/Concept |
|---|---|
| Total overseas spend (tos): | sum(billing_amount) per customer_id |
| | over last 6 months where |
| | transaction_currency ≠ “784” |
| Total domestic spend (tds): | sum(billing_amount) per customer_id |
| | over last 6 months where |
| | transaction_currency = “784” |
| % spent overseas (pos): | (tos/(tos + tds))*100 |
| % spent domestic (pds): | (tds/(tos + tds))*100 |

Quarterly Spend Change. Quarterly Spend Change measures the percentage change in current quarter spends vs. previous quarter spends at customer level. Mathematical derivation of this metric is difference of total spends in current quarter and previous quarter divided by previous quarter spend in percentage terms.

TABLE 10

| Outputs | Formula/Concept |
|---|---|
| Total spend in | sum(billing_amount) per customer_id |
| quarter-3 (spq3): | where 2013 Jul. 1 ≦ txn_date ≦ |
| | 2013 Sep. 30 |
| Total spend in | sum(billing_amount) per customer_id |
| quarter-4 (spq4): | where 2013 Oct. 1 ≦ txn_date ≦ |
| | 2013 Dec. 31 |

$$Quarterly Spend Change \text{:} \frac{( spq 4 - spq 3 ) * 100}{spq 3} , at \\ customer level \qquad ( Equation 5 )$$

Redemption Options Utilization. Redemption Options Utilization indicates how many types of redemption options customer is availing for reward points' redemptions. Mathematical derivation to calculate this metric is to count the unique number of redemption options opted by the customer from reward data of 3 years.

TABLE 11

| Outputs | Formula/Concept |
|---|---|
| Redemption count | table containing count of distinct |
| over 4 categories | posting_dates per customer_id across |
| (rc_tab): | redemption actions (5 redemptions |
| | options were collated into 4)* |
| | * STARS_CARD_REDEMPTION = |
| | STARS_CARD_REDEMPTION + |
| | STARS_CARD_RELOAD |
| | Calculated over a period of 3 years |

$$\begin{matrix}Count of Redemption Actions \text{:} count ( redemption \\ actions with nonzero \# of redemptions ) per \\ customer\_id & ( Equation 6 ) \\ Percent Usage of Redemption Actions \text{:} \\ \frac{\begin{matrix}count ( redemption actions with nonzero \# \\ redemptions ) * 100\end{matrix}}{4} per \\ customer\_id & ( Equation 7 )\end{matrix}$$

Spend on Essential Items. Spend on Essentials Items shows how much customer is utilizing the card for purchasing essentials items (groceries, fuel, clothing). For every bank, we have defined the list of essential merchant categories. This metric is calculated in two dimensions: the first is spend at monthly level in last 6 months, and second is total spend in last 6 months.

TABLE 12

| Outputs | Formula/Concept |
|---|---|
| Spend across essential items | sum(billing_amount) across essential |
| at customer level; monthly | categories per customer_id in a |
| and at 6 months: (seᵢ) | single month or 6 months when |
| | ess_flag = “Essential” |
| Total spend at customer level; | sum(billing_amount) per customer_id |
| monthly or 6 months: (ts) | in a single month or 6 months |
| % of total amount spent across | (se_{i/}ts)*100 |
| essential items at customer | |
| level; monthly or 6 months: | |
| (pseᵢ): | |
| # txn across essential items | count of unique transaction ids |
| at customer level; monthly or 6 | across essential categories per |
| months: (txeᵢ) | customer_id in a single month or 6 |
| | months when ess_flag = “Essential” |
| Total # txns at customer level; | count of unique transaction ids per |
| monthly or 6 months: (ttx) | customer_id in a single month or 6 |
| | monthly |
| % of total amount spent across | txe_{i/}ttx |
| essential items at customer | |
| level; monthly or 6 month: | |
| (ptxeᵢ): | |

Sustained Merchants Shopped. Sustained Merchants Shopped quantifies the undeviating shopping behavior of customers in last 6 months. We have defined sustained merchant categories group: if customer has consistently shopped basket of unique MCC at least 4 months out of 6 months. More numbers of unique categories shopped consistently leads to more engagement of customer.

TABLE 13

| Outputs | Formula/Concept |
|---|---|
| List of MCCs shopped per | Identify the list of unique MCCs |
| customer separately for | shopped per customer_id in a |
| each month | single month |
| Consolidated list of MCCs | Merge the individual list for each |
| shopped per customer for | month in one consolidated dataset |
| all the months | for further analysis |
| Sustained list of MCCs | An MCC is sustained if it occurs in at |
| shopped over 6 months | least 4 months' lists. Then store |
| | the list of sustained MCCs per customer_id. |
| Count of Sustained MCCs | Count the number of MCC in the list |
| shopped over 6 months | previously calculated at customer level. |

Reward Value Utilization of Net Spend. Reward Value utilization is the ratio of reward value (point's monetary value) and Net Spend to understand the customer redemption behaviour vis-a-vis spend when they redeem reward points. Mathematical formulation of this metric is the ratio of reward value and net spend (total spend-reward value).

TABLE 14

| Outputs | Formula/Concept |
|---|---|
| Total points at unique | sum(points) across redemption actions |
| redemption level | at unique posting_date level |
| Conversion of total points to | multiply the respective conversion |
| monetary value | ratios to the summed points under |
| | various actions |
| Total monetary reward value at | sum of converted monetary reward |
| unique redemption level | values across different actions at |
| | unique posting_date level |
| Total reward value per | sum the reward values at |
| customer: (trv) | customer_id level |
| Total spend per customer: (ts) | total spend by customer_id |
| Net spend: (ns) | (ts − trv) |
| Reward value as % of net spend | (trv/ns)*100 |

### CES System and Scoring

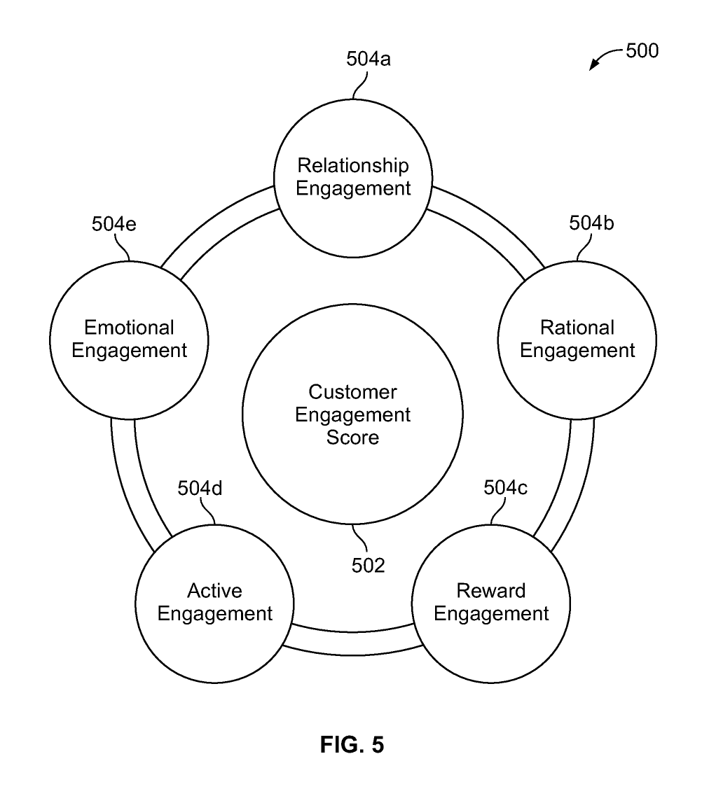

The CES as described herein is based on the concept of ERRRA (Emotional, Relationship, Rational, Reward Utilization, and Active Engagement). The ERRRA framework, reflected through the CES, shows customers' relationship with a company over time. It allows a company, such as a bank, to attract and influence customers in order to hold their attention and induce them to participate in a long term relationship with the company. In FIG. 5, the five factors making up the ERRRA framework are shown: relationship engagement 504a, rational engagement 504b, reward engagement 504c, active engagement 504d, and emotional engagement 504e. These factors are reflected in the CES 502.

The determination and analysis of customer engagement is a continuous process for improving customers' day to day level activities and improving stickiness with a company, such as a bank. Identifying drivers of engagement, and taking action to improve those drivers, is also an iterative process to bolster the customer relationship. Analyzing an individual business attribute does not provide a comprehensive view of a customer's intrinsic loyalty. In addition, attributes can be highly correlated to each other and some attributes can give conflicting signals.

It is helpful to look at the engagement at the segment level because similar types of customers, based on their spending & usage pattern, shopping behavior and pattern, reward utilization, and spend on diversified merchants, can be classified into a segment and dissimilar types of customers can be analyzed across segments. Insights on engagement at the individual segment level will help understand and identify where a given type of customer segment stands in relation to others, and may identify actions that can be taken to improve engagement for that particular segment. The engagement benchmarking can be done within and/or across segments to define frontier of engagement.

Therefore, the determination and analysis of customer engagement may be a multi-pronged and iterative process. There are several statistical methods for measuring the engagement but most of them have certain limitation to their weightage in calculating consolidated composite score or index. The multivariate factor analysis, principal component analysis (PCA) doesn't provide comparable composite index when attributes are in different scale of measurement and PCA driven orthogonal variables are not directly comparable. Considering the limiting factors above, and the desire to maximize the ERRRA factors, the following method has been used to measure the customer engagement score.

Create Data Matrix. Let X be our data matrix of credit card customer transactional activity, depth and breadth of relationship, customer's demographic information, etc. Then X can be defined as follows:

X=[[xᵢⱼ]]_{n×p} (Equation 8)

where i=1(1)n; j=1(1)p; n=# customers; p=# variables. Therefore, X will look like:

$$( \begin{matrix}{x}_{11} {x}_{12} {x}_{13} & … & {x}_{1 p} \\ ⋮ & ⋱ & ⋮ \\ {x}_{n 1} {x}_{n 2} {x}_{n 3} & … & {x}_{np}\end{matrix} ) \qquad ( Equation 9 )$$

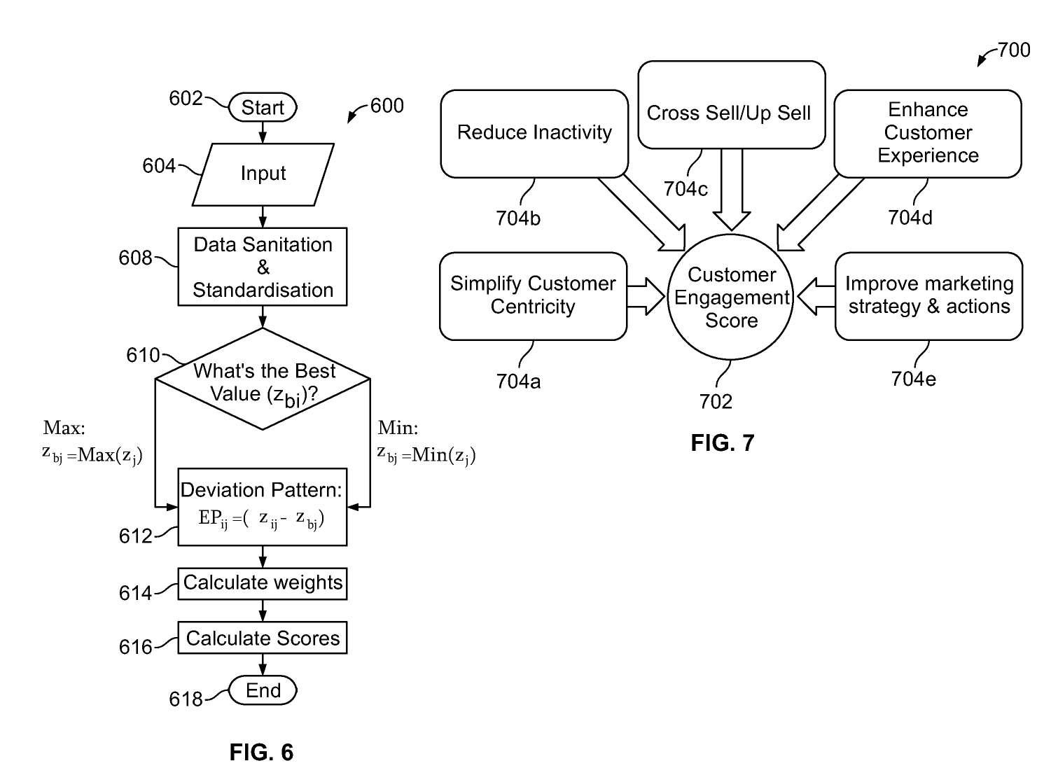

The process of determining a composite score includes the steps of standardization, identifying best values for each variable, calculating the pattern of engagement, calculating the composite index, and calculating the customer engagement score. The process is illustrated in FIG. 6. The process starts at 602, and at 604 the input data is collected for the calculation of the CES.

Standardization: At 608, the input data is standardized. Since [xᵢⱼ]'s come from different population distributions and are recorded in different units of measurement, they are not quite suitable for simple addition for obtaining a composite index. Therefore, [xᵢⱼ]'s were transformed to as follows:

$${z}_{ij} = \frac{( {x}_{ij} - {\overline{x}}_{j} )}{{s}_{j}} \qquad ( Equation 10 )$$

Where X̅ⱼ=Mean of the j^{th} variable Xⱼ and Sⱼ=Standard deviation of the j^{th} variable Xⱼ. Thus the standardized data matrix Z is provided for further analysis.

Identify Best Value for Each Variable: Using the standardized data matrix Z, at 610, the best value for each variable is identified. In FIG. 6, Zbⱼ denotes the Best Value of the j^{th} variable. The best value could be either maximum or minimum of the j^{th} variable depending upon the direction of impact of the variable on the level of engagement as decided by business context. As some examples, for customers' total spend in last 6 months (mon_t×n_6 m) (see 402j, 404j) and total transactions in last 6 months (freq_t×n_6 m) (see 402i, 404i) would have best values when the value is maximized, because the relationship is great from the company standpoint if the customer is conducting many high value transactions. But for a variable such as recency (see 402r, 404r), a minimum value would be preferred (representing a small time period since the last transaction)—in other words, if the shopping interval is low, then the customers are more active and engaged.

Calculate Pattern of Engagement. At 612, the pattern of engagement EPᵢⱼ is obtained as follows:

EPᵢⱼ=(zᵢⱼ−z_{bj})² (Equation 11)

Here, the square of the deviation of best value from its standardized value has been calculated for each variable to avoid impact of positive or negative sign of the underlying attributes' distance from its best value while measuring the pattern.

Calculate Weighted Index. At 614, the pattern of engagement is calculated the for the i^{th} customer as follows:

$${CI}_{i} = \sqrt{{\sum }_{j = 1}^{p} \frac{{EP}_{ij}}{{VMR}_{j}}} \qquad ( Equation 12 )$$

The pattern of engagement is calculated by taking the square root of the sum of the engagement pattern (from 612) divided by the Variance to Mean Ratio (VMR) for the j^{th} attribute in the original X data matrix. Variance to Mean Ratio is treated as weight of individual attribute for comparative score of engagement, and is determined by:

$${VMR}_{j} = \frac{{σ}_{j}^{2}}{{μ}_{j}} , \qquad ( Equation 13 )$$

where σⱼ² is the variance and μⱼ is the mean of original business attributes.

Calculate Customer Engagement Score. At 616, the weighted index is used to arrive at the composite score CSᵢ as:

$${CS}_{i} = \frac{{CI}_{i} - Min ( CI )}{Max ( CI ) - Min ( CI )} \qquad ( Equation 14 )$$

From the model, a lower value of score CSᵢ will indicate a high value of engagement and higher value of the score will indicate lower value of engagement of customer. According to a preferred embodiment, it is optimal to change origin and scales to reflect a score in the range 0-1000. This change provides a more intuitive definition of CES where a larger score indicate stronger engagement and lower CES indicate weaker engagement of customers. This adjustment can be made using the following formula:

CESᵢ=(1−CSᵢ)×1000 (Equation 15)

Using substitution and simplification, the final result is:

$${CES}_{i} = \frac{Max ( CI ) - {CI}_{i}}{Max ( CI ) - Min ( CI )} \times 1000 \qquad ( Equation 16 )$$

At 618, the CES calculation has been determined and the process ends.

Turning to FIG. 7, the customer engagement analytics provides a number of business benefits. For example, the CES 702 provides a framework to:
Simplify Customer Centricity 704a which allows for extraction of customer's behavior, attitude, emotion and intelligence from a single composite numeric score.
Reduce Inactivity 704b by understanding customer's inactivity and building early warning indicators and proactive retention measures in advance of actual customer attrition. For example, a Trigger & Business rule can be developed, such as a rule stating that if pacing rate has been increased by 10% and average transaction value has been reduced by 20% or more, then it is likely that the customer will be inactive over a 3 month period of time.
Cross Sell/Up Sell 704c product & services. The company can drive its cross selling strategy based on the engagement value, for example a specific product and/or service can be offered to the customer based on their needs and engagement. For example, if a customer has a high engagement score and belongs to the traveler segment, that customer can be effectively cross sold an airline co-branded credit card with improved travel benefits to better address that customer's need.
Enhance Customer Experience 704d through customer interactions based on engagement. For example, based on the engagement level, differentiated personalized service (such as a preferred customer access line), customized offers, & other benefits can be provided to highly engaged customers to convey the message that the company cares about and appreciates the customer's needs.
Improve Marketing Strategy and Actions 704e. The CES may be used to optimize marketing budgets, improve campaign response rates, and reduce costs while building targeted marketing action plans.

FIGS. 8-12 show exemplary analysis reports that are provided at 108 via the insights visualization application (IVA) displays.

In FIG. 8, a summary analysis for the crown jewel segment 802 is provided. The analysis can show a variety of information relating to the variables discussed above, such as spending/usage per customer 824, average transaction value and merchant category code 826, pacing rate 842, and other information. The analysis also includes the CES calculations for applicable customers 866. By looking at the data as applied to a single segment (here, crown jewels) a strong understanding of the differentiated spending, utilization, and MCC metrics can be developed. This allows for insights to be generated by segment and by product, and adjustments to be made. For example, in FIG. 8 a focus on low pacing rate customers with over 3 months of inactivity could be targeted (as shown in the lower right box of 842). The IVA display allows for download of a customized customer list with key metrics that can be used to initiate action through marketing channels, such as direct customer communications via call center, SMS, email, and other means.

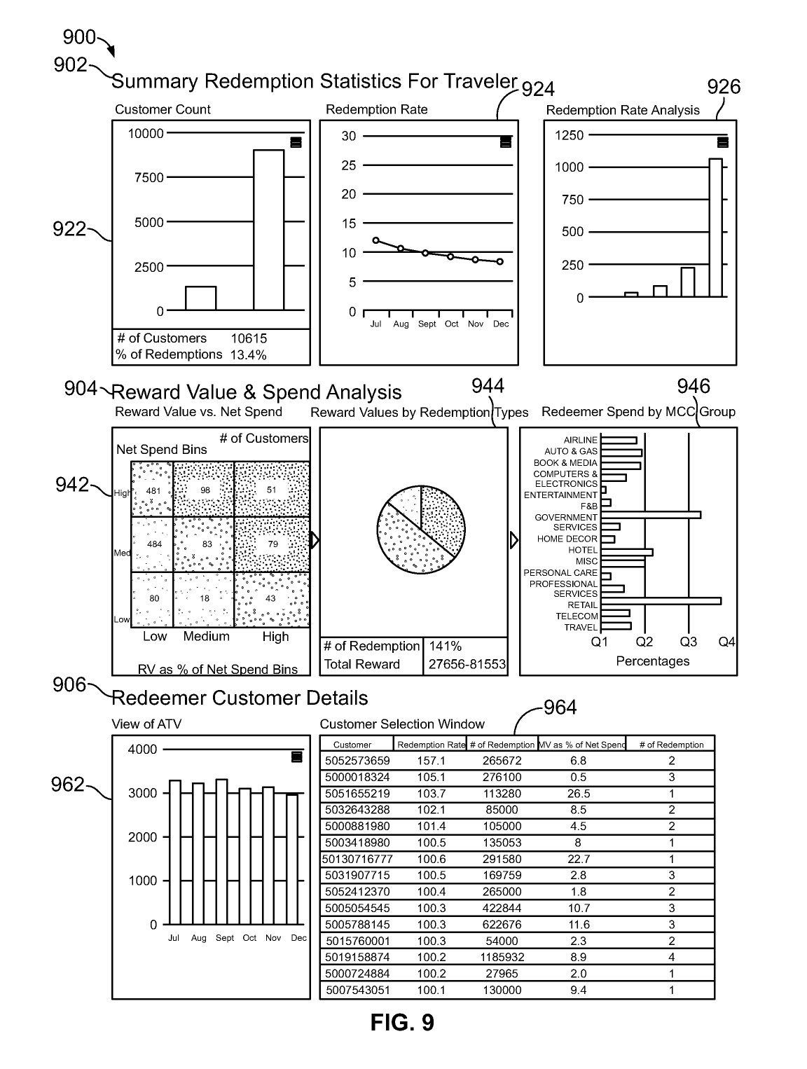

Turning to FIG. 9, analysis for the traveler segment is provided. The IVA display 900 shows redemption data 902, reward and spend analytics 904, and customer details 906 for the traveler segment.

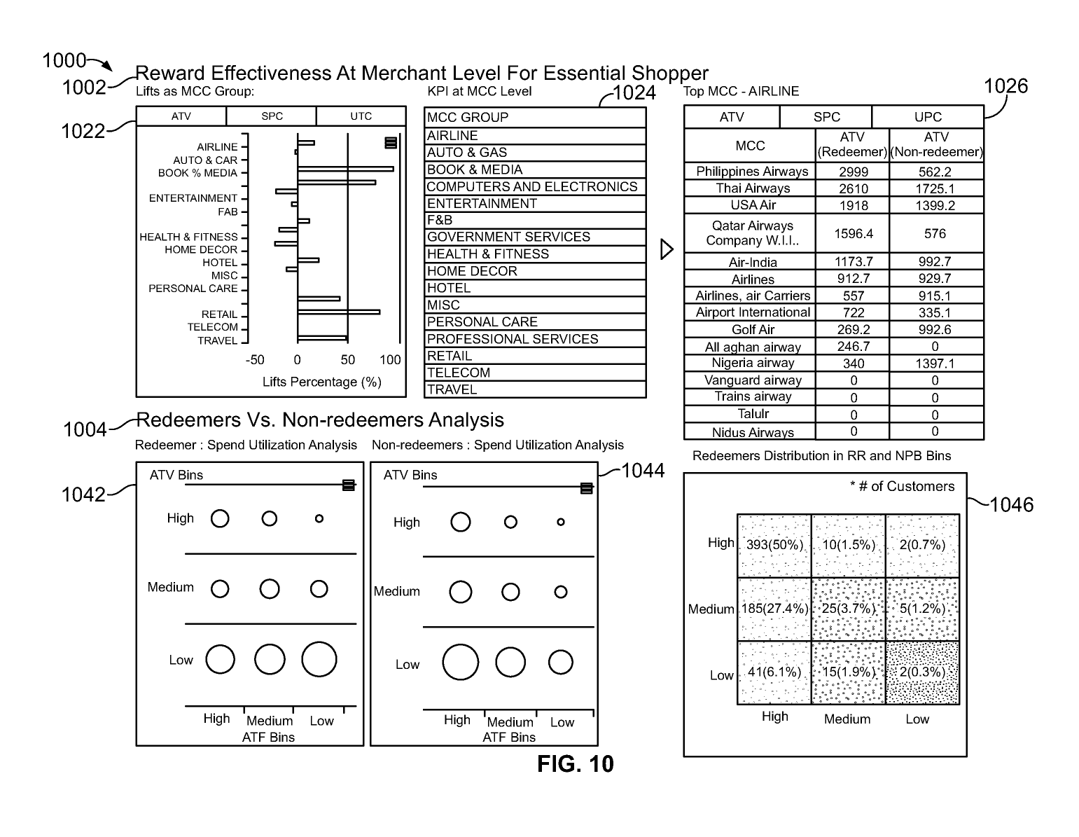

Turning to FIG. 10, another analysis is shown. Here, the analysis is focused on the essential shopper segment, and provides information on reward effectiveness 1002 and comparison data for redeemers vs. non-redeemers 1004. The IVA displays shown here in FIGS. 8-12 are exemplary, and demonstrate some of the analysis available from the CES process that can be used by a company such as a bank to gain valuable insights into reward liability, effectiveness of rewards and merchant performance, for example.

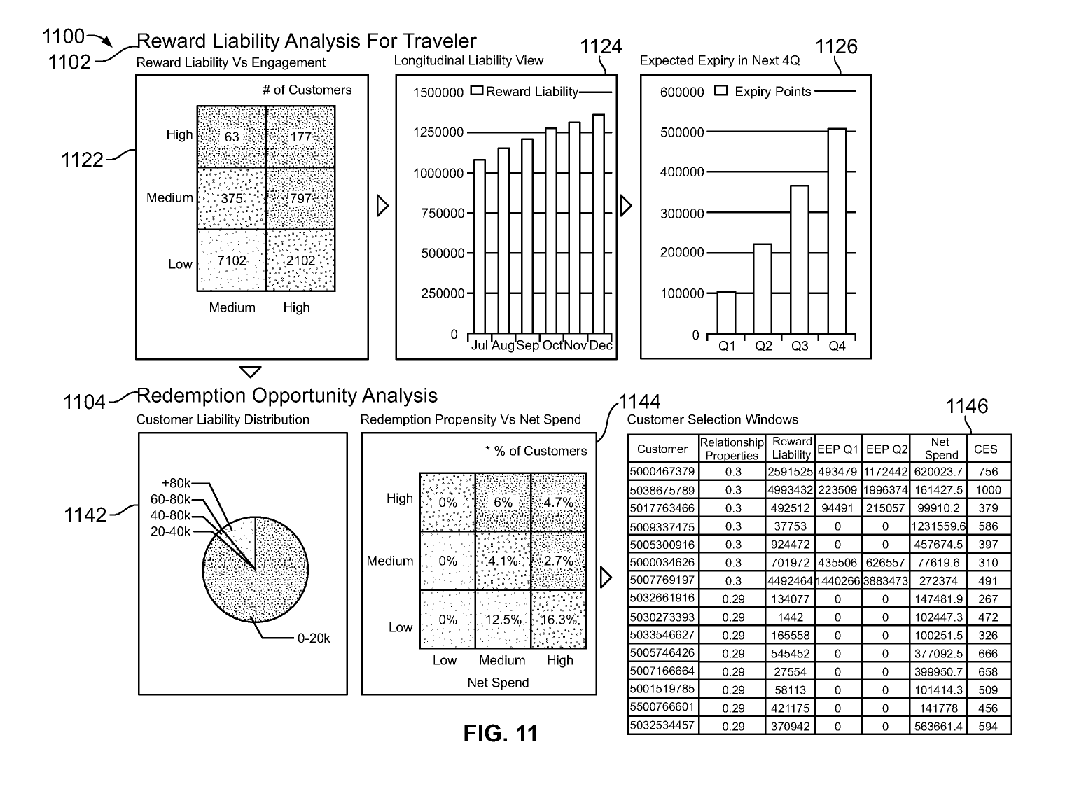

Turning to FIG. 11, an IVA display providing reward liability 1102 and redemption opportunity analysis 1104 for the traveler segment is shown. The reward liability analysis 1102 includes a comparison of reward liability vs. engagement 1122, a longitudinal liability view 1124, and expected expiry of reward points over the next year 1126. The redemption opportunity analysis includes a customer liability distribution 1142, a comparison of redemption propensity vs. net spend 1144, and customer specific information 1146.

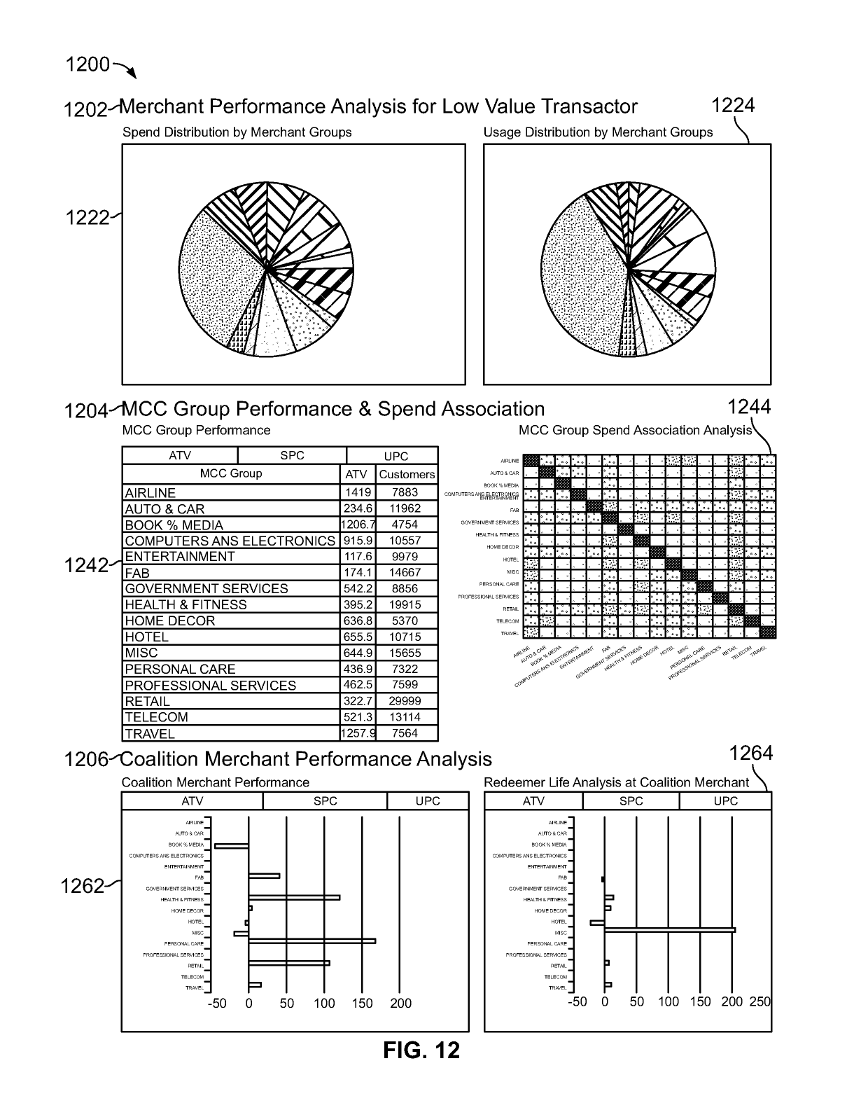

Turning to FIG. 12, an IVA display providing merchant performance analysis for the low value transactor segment 1202 is provided, along with analysis for MCC group performance and spend association 1204, and coalition merchant performance analysis 1206.

Turning to FIG. 13, a method for evaluating sensitivity and optimizing engagement is provided. At 1304, the user first selects the range of scores which requires improvement. For example, the user might select customers with CES less than 350 as those requiring optimization. Next, at 1306 the customer segment is considered to further refine the list of suboptimal customers which needs optimization with an objective to improve customer's engagement. At 1308, the performance relative to the ERRRA parameters is considered, and at 1310 a list of KPI's is created which can improve customer engagement. For example, the emotional engagement might be a weak factor in the Traveler segment and therefore is worthy of further analysis. Then, at 1312 each KPI which falls under this factor is evaluated for strength. Sensitivity of change in CES for unit change in the KPI is evaluated. This can be done for one or multiple KPIs in that factor. At 1314, at the customer level, the impact of change in CES for change in KPIs is calculated and a set of customers are identified for specific intervention. At 1316, a specific strategy is determined for the targeted customer set, to increase the level of performance of the selected attributes and therefore improve the degree of engagement.

Turning to FIG. 14, an example recommendation is provided. In this example, a process for proactively managing retention is shown. Shown at 1402, the bank can select customers who meet the criteria of strong past purchase patterns regarding card transaction behavior, but no activity in the past 3 months. In this example, 31.7% of customers meet these criteria and can be targeted for a specific retention campaign. Referring to 1404, the bank can evaluate where the customers were spending prior to inactivity, so that specific reward framing can be presented based on a customer's prior behavior.

A specific retention campaign can be developed for these customers. In addition, business rules can also be developed such as: If the pacing rate of customer increases by 10% over a 3 month moving average, and the ATF of customer has reduced by greater than 20% Q-on-Q, then put that customer in a retention intervention list. In some embodiments, these business rules can be setup using a loyalty program used by the business. In some embodiments, the business rules can be implemented using miLoyalty, the Zafin loyalty management platform, to automatically flag customers at attrition risk.

As shown at 1406, a plan for “win-back” marketing campaigns and proactive retention strategies can be implemented using a mathematical algorithm based on the engagement score to optimize the cost and reach out to key customers with a personalized approach. Here, the top priority customers are identified based on the combination of the inactive customer base identified at 1402 combined with a CES of 800 or more 1464a.

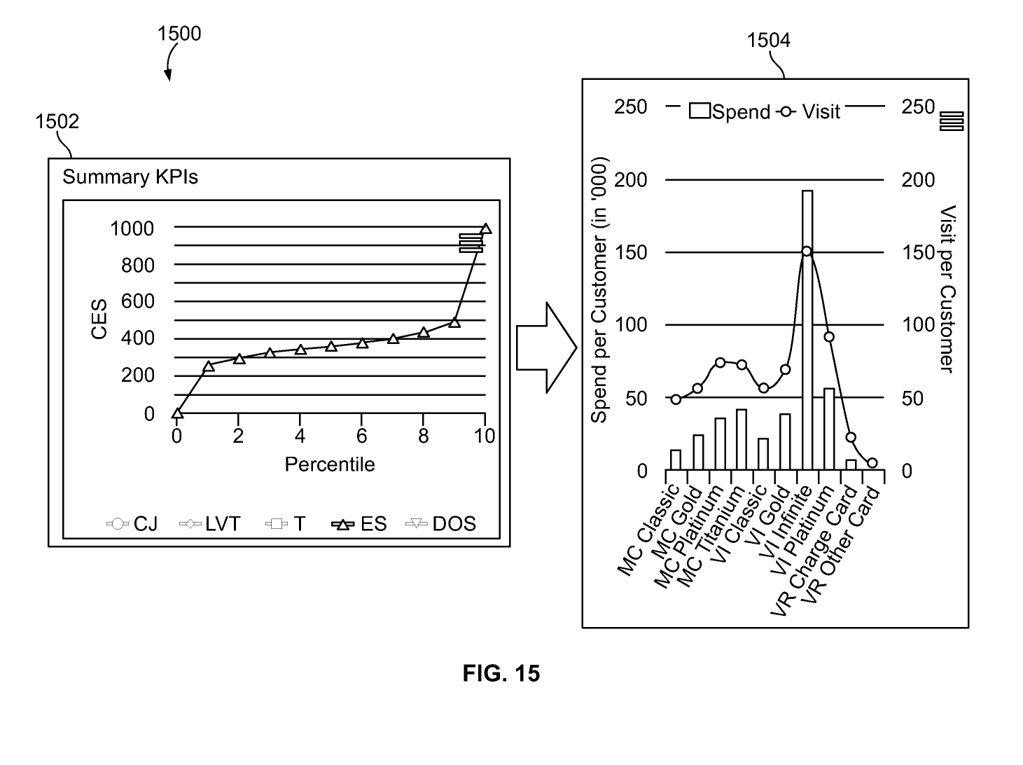

Turning to FIG. 15, another example recommendation is provided. In this example, the CES process is used to identify upselling opportunities in the customer base. This is valuable because, for example, a bank is constantly looking for opportunities to increase usage and average transaction value of card spend in its customer base. In the system, customers can be segmented based on a number of factors, such as their transactional and psychographic behavior. For example, the essential shopper segment, shown at 1502, is defined as spending primarily on non-discretionary items only, such as food and clothing. Focusing on the essential shopper segment, customers with relatively high engagement (for example, a 400+ score) can be targeted for a 3 month card credit limit extension (for example, by 25%) during the holiday season like Christmas. This can be combined with an educational campaign to educate the customers on the increased card limit as well as offer special reward incentives at specific coalition merchant partners. But, as shown at 1504, only customers having Visa Platinum & Visa Infinite show high spending for these products, and therefore the program should be focused on these customers.

The bank can evaluate the return on investment for the program after the 3 month campaign, based on the effect on CES, and then adjust the thresholds or the coalition partners for future campaigns as necessary.

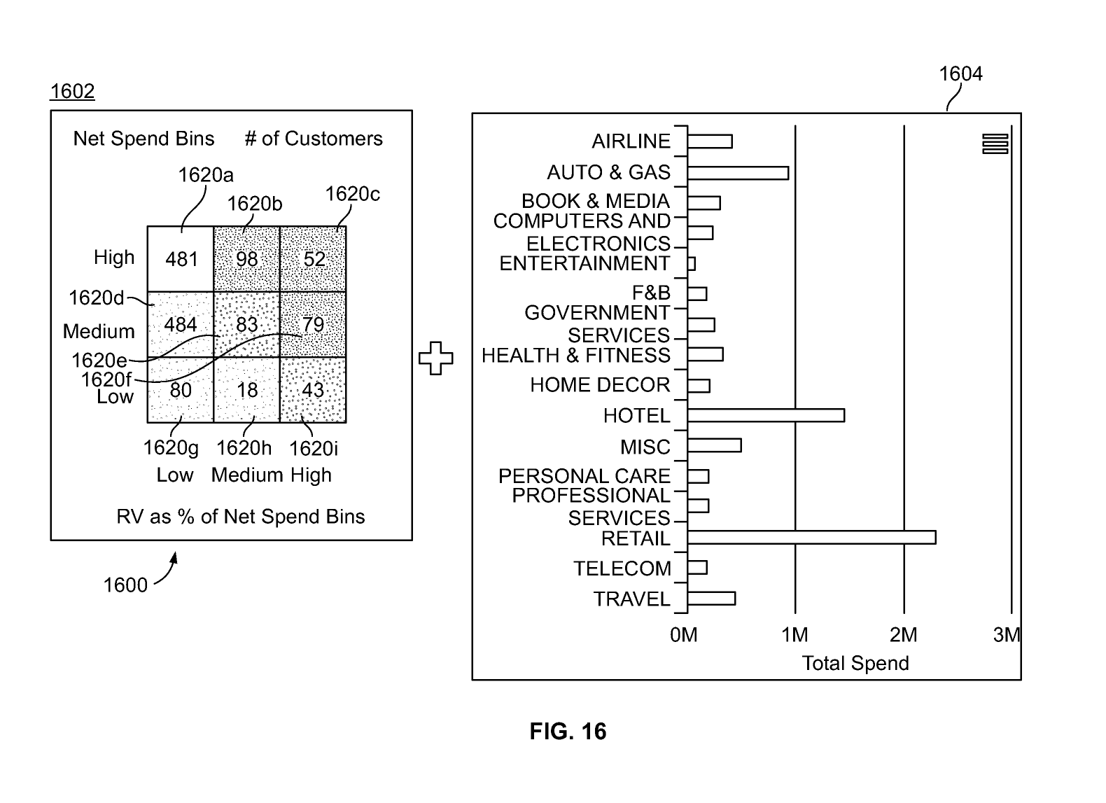

Turning to FIG. 16, yet another example recommendation is provided. A company, such as a bank, is constantly looking to reward their best customers for their continued patronage and loyalty. Here, the goal is to identify customers that are not redeeming accumulated rewards points and offer them a relevant opportunity to redeem their points. In this example, at 1602, a chart is provided for customers in the travelers segment that spent a significant amount, but don't redeem a high value of rewards. As shown in the chart at 1620a, 481 customers meet these criteria. These customers are valuable customers for the bank and by improving redemption among these customers, the bank can improve its customer engagement and overall loyalty. To better evaluate what redemption offers would be well received, the chart 1604, showing the redemption patterns for highly engaged and redeeming customers, can be analyzed. Then the bank can offer a specific reward framework for bulk redemption by its customers in these areas (in this example, Hotel, Retail, and/or Auto-Gas). The expectation is these offers will improve the customer engagement for the targeted category of travelers as well as increase spend in contextual categories that are related to travel spend. For additional targeting, the information here can be combined with the CES value to offer more personalized offers, for example, personalized services and products can be offered for reward points to high value customers with a CES above 500.

The above examples provide several contexts for analyzing customer behavior using the CES process of the present disclosure. Many other recommendations may be prepared based on specific engagement goals combined with analysis of spending type, segmentation, recency, reward value, pacing rate, product type, and many other factors. The CES process provides a defined framework to evaluate engagement based on numerous factors and customize recommendation(s) appropriate for specific customers or groups of customers. Additional recommendations and implementation options are possible when combining the CES process with a customer loyalty analytics solution, such as miLoyalty by Zafin.

One such cross-product enterprise reward analytic example is the following. Assume that a transaction analysis reveals that a small business owner with a high Customer Engagement Score (CES) prefers to deposit checks at the branch. However, the bank's goals are to improve the cash conversion cycle while reducing the cost to serve, and therefore a manual deposit at the branch is undesirable. The bank therefore offers the customer an incentive with free remote deposit capture via a mobile device and a points-based reward. The customer is then incentivized to enjoy a streamlined deposit process and extra loyalty points, while the bank can access the deposits quicker and meet its goals.

As a second example, assume a customer with a car loan has a history of late payments and associated fees. Analytics-based segmentation categorizes this customer as ‘Upwardly mobile Generation Y’, with a strong preference for digital channels. The bank therefore incentivizes the customer to switch to pre-authorized debit payments. The customer is then incentivized to avoid penalty fees and enjoys a reward, while the bank mitigates its credit risk.

In order to better evaluate the customer engagement, with the goal of designing better targeted marketing strategies, reward programs, and other incentives tailored to particular customer groups, it is valuable to segment the customer base into groups. According to some embodiments, a proprietary SMART segmentation process is used to achieve this goal. SMART segmentation is an unsupervised machine learning based algorithms aimed at grouping customers in segments based on customers spend, merchant category shopped, reward utilization & redemption behavior and transactions. The segmentation has been developed using a customer's transaction history across a 6 month period, and the algorithm has been designed to assign each customer a segment based on their spend, transaction, shopping behavior & pattern, and redemption pattern.

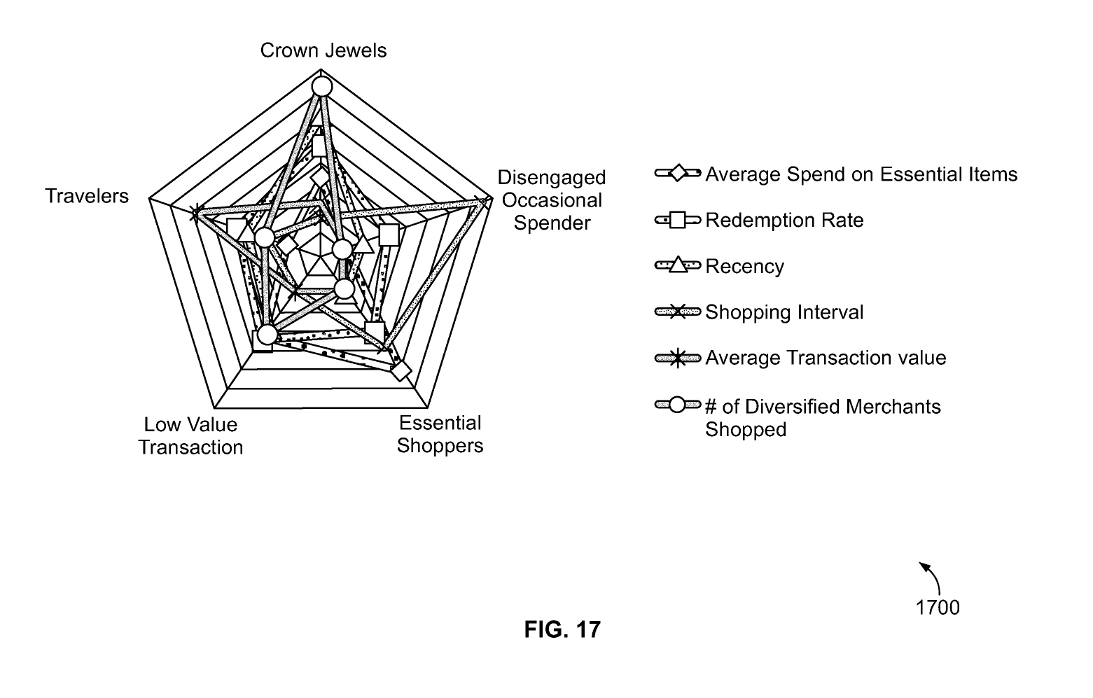

Turning to FIG. 17, the five SMART segments are charted against six transaction based measures: average spend on essential items, redemption rate, recency, shopping interval, average transaction value, and number of diversified merchants shopped. The five SMART segments are defined as follows:

Crown Jewels (CJ): These customers are highly active transactors with a high purchase rate. Some of these customers might revolve balances based on their payment profile. Since such customers use the card as top of wallet, you will see diversity of spend domestically and globally. A reasonable portion of these customers consistently derive benefits from the reward program and actively redeem points on available redemption options such as travel miles, merchant vouchers and gift cards. Their spending horizon is broad and crosses merchants categories.

Disengaged Occasional Spender (DOS): As the name suggests, these customers use their cards once every couple of months and spend on essential non-discretionary items like Groceries, Clothing and Fuel but generally in small amounts. Potentially over a third of these customers have not performed a transaction in the last 3 months. Their spending footprint across merchants is also very low. A very small percentage of such customers have done one or more redemptions, which is low as compared to other segments.

Essential Shoppers (ES): Customers in this segment spend strongly on essential non-discretionary items like Groceries, Fuel and Clothing. They utilize their cards for basic needs and charge them in every other week (low pacing rate). They tend to redeem points quickly and utilize most of their reward value on merchant redemption versus other redemption options. Overall spending levels are moderate due to the budget constrained nature of these customers.

Low Value Transactors (LVT): These customers spend their money across all merchants but ticket size is low. In some ways they are “poor cousins” of Crown Jewels. They shop and charge their card at least once in a week and they utilize at least half of their reward value on product or voucher redemptions. They are moderately engaged customers and do at least one transaction a week.

Travelers (T): These customers have a traveler profile and a majority of them travel overseas. Customers' average spend in this segment is quite high. Most of spending is on travel related categories like airlines, hotel, food and beverage, and fuel. A good proportion of revenue comes from international spending. The customers in this segment are not highly engaged as they do not utilize their cards for basic needs. Their pattern of usage can also be seasonally tied to vacation time (for example, October-December timeframe). The number of merchant categories shopped per customer is also low and travel centric.

Using the teachings of the present disclosure, a customer's intrinsic loyalty can be evaluated and improved throughout the customer lifecycle. At an initial stage, a new account is activated and a new customer is acquired (for example, a credit card is issued to the customer and activated). Next, during the usage phase, insights are developed into customer centricity and reward and loyalty decisions, through use of the credit card by the customer. This enables measurements for the effectiveness of reward programs and identifications of key levers to improve customer usage and spending rates. At this stage, determination of the customer engagement score reveals relationship value quantitatively, and allows one to measure the drivers of engagement and inactivity to improve depth, breadth & stickiness of the relationship.

In the next stage of the lifecycle, retain & engage, the customer engagement score is analyzed and strategies are developed to migrate customers from low value to high value segments, and, if applicable, improve reward redemption behavior. The application of these strategies causes a shift in the customer's behavior in the next stage of the lifecycle. The process can be continued using the customer's additional transactions to determine a new engagement score, and additional actions can be taken as determined necessary. Additional analysis may also be performed as the customer adds additional accounts, such as additional cards. The process of evaluating usage data, determining engagement, and acting to improve engagement and retention is ongoing throughout the customer lifecycle.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the invention. It is also contemplated that additional embodiments according to aspects of the present invention may combine any number of features from any of the embodiments described herein.

What is claimed is:

1. A method for evaluating and improving customer engagement, comprising:
receiving transaction-related information for a plurality of customers;
identifying, based on the transaction-related information, a segment from a set of segments applicable to at least one of the plurality of customers;
selecting a list of preferred variables for determining a customer engagement score and determining the best value for each variable in the preferred list of variables;
calculating a customer engagement score for at least one of the plurality of customers; and
determining at least one recommendation to improve engagement for at least one of the plurality of customers, the recommendation based at least in part on the analysis of the customer engagement score and the identified segment for the at least one of the plurality of customers.

2. The method of claim 1, wherein the transaction-related information comprises merchant category code data and at least one of credit card transaction data or debit card transaction data.

3. The method of claim 1, wherein the transaction-related information comprises reward accrual data and reward redemption data.

4. The method of claim 1, wherein the transaction-related information comprises card account and customer data.

5. The method of claim 1, wherein the set of segments comprise crown jewel, disengaged occasional spender, essential shopper, low value transactor, and traveler segments.

6. The method of claim 1, wherein the list of preferred variables is selected based on the ERRRA factors for the transaction-related information.

7. The method of claim 1, further comprising displaying a summary analysis for the identified segment, the summary analysis comprising the customer engagement score and key performance indicators for a plurality of customers in the identified segment.

8. The method of claim 1, further comprising displaying a summary analysis for the identified segment, the summary analysis comprising reward value and redemption statistics for a plurality of customers in the identified segment.

9. The method of claim 1, further comprising displaying a summary analysis for the identified segment, the summary analysis comprising a measurement of the effectiveness of a reward program for at least one customer loyalty metric for a plurality of customers in the identified segment.

10. The method of claim 1, further comprising displaying a summary analysis for the identified segment, the summary analysis comprising the spending distribution for a plurality of customers in the identified segment and merchant group performance for merchants shopped by the plurality of customers in the identified segment.

11. The method of claim 1, further comprising communicating the at least one recommendation to a loyalty management platform.

12. The method of claim 1, wherein the at least one recommendation further comprises the projected impact of implementing the at least one recommendation on the customer engagement score.

13. The method of claim 1, wherein the at least one recommendation comprises a recommendation to optimize reward liability for a plurality of customers in the identified segment, the recommendation further based at least in part on a predictive model for expected reward redemptions.

14. The method of claim 1, further comprising implementing the at least one recommendation and, at a later time, recalculating the customer engagement score to determine the impact of the at least one recommendation.

15. A method for evaluating and improving customer engagement, comprising:
receiving transaction-related information for a plurality of customers;
identifying, based on the transaction-related information, a segment from a set of segments applicable to at least one of the plurality of customers;
calculating a weighted index from a set of selected variables based on the transaction-related information;
determining a customer engagement score, from the weighted index, for at least one of the plurality of customers;
displaying a summary analysis for the identified segment including the customer engagement score for at least one of the plurality of customers within the identified segment;
evaluating the sensitivity of the customer engagement score to a change in the value of each of the selected variables, wherein a highly sensitive variable has a large impact on the customer engagement score; and
recommending at least one strategy to increase the customer engagement score, by impacting the value of at least one highly sensitive variable.

16. The method of claim 13, wherein the transaction-related information comprises merchant category code data and at least one of credit card transaction data or debit card transaction data.

17. The method of claim 13, wherein the transaction-related information comprises reward accrual data and reward redemption data.

18. The method of claim 13, wherein the set of segments comprise crown jewel, disengaged occasional spender, essential shopper, low value transactor, and traveler segments.

19. The method of claim 13, further comprising communicating the at least one recommendation to a loyalty management platform.

20. The method of claim 13, further comprising implementing the at least one strategy and, at a later time, recalculating the customer engagement score to determine the impact of the at least one strategy.
